(19) United States
(12) Patent Application Publication
(10) Pub. No.: US 2026/0088902 A1
(43) Pub. Date: Mar. 26, 2026

(54) METHODS AND SYSTEMS FOR LAST MILE CABLE-TELEVISION DATA TRANSMISSION TO SUBSCRIBERS OVER FIBER-OPTICS

(71) Applicant: Broadband International Inc., Medley, FL (US)

(72) Inventor: Dogan Atlas, Atlanta, GA (US)

(21) Appl. No.: 19/336,004

(22) Filed: Sep. 22, 2025

Related U.S. Application Data
(60) Provisional application No. 63/697,271, filed on Sep. 20, 2024.

(51) Int. Cl. H04B 10/2575; H04B 10/556

(52) U.S. Cl. CPC H04B 10/25751; H04B 10/25759; H04B 10/5563

(57) ABSTRACT

A cable network system comprises: a headend; a node communicatively coupled to the headend via digital fiber-optic links, the node implementing one or more of Remote PHY (RPHY) or Remote MAC (RMAC) protocols; wherein the node comprises a first electro-optical converter configured to convert a baseband digital signal into a Frequency-Division Multiplexed (FDM) optical signal; and wherein the node is configured to send the FDM optical signal over an optical cable to a second electro-optical converter located at a user's premises, and receive an FDM optical signal from the user's premises. The sent and received FDM optical signals may be wavelength division multiplexed such that they may have at least partially overlapping frequency bands.

### CROSS-REFERENCE TO RELATED APPLICATIONS

This application claims priority to U.S. Provisional Application 63/697,271, filed on Sep. 20, 2024, the contents of which are hereby incorporated in their entirety.

### FIELD

The present disclosure generally relates to the field of fiber-optics in cable television systems. In particular, the present disclosure is related to methods and systems for last-mile cable-television data transmission to subscriber over fiber-optics.

### BACKGROUND

Cable television (CATV) is a form of broadcasting that transmits programs to paying subscribers through a physical land-based infrastructure of coaxial cables or through a combination of fiber-optic and coaxial cables rather than through the airwaves. Cable television networks based on coaxial distribution have been deployed for over half a century. The main function for early cable systems was to provide television service to areas where off-the-air reception was unavailable. In the past thirty years, most cities and county locations have been wired for cable television services. CATV transmission, however, has been designed mostly to optimize downstream broadcasting; it was not configured for upstream receipt of information from subscribers. Even though upstream transmission has existed for years, some recent advances and customer requirements have increased the kind and amount of upstream transmission to such an extent that the infrastructure for transmitting that upstream information has issues needing to be corrected and/or improved. A dedicated radiofrequency (RF) bandwidth that provides greater bandwidth for customers is needed.

### SUMMARY

In an embodiment, a cable network system comprises a headend and a node communicatively coupled to the headend via digital fiber-optic links, the node implementing one or more of Remote PHY (RPHY) or Remote MAC (RMAC) protocols. The node comprises a first electro-optical converter configured to convert a baseband digital signal into a Frequency-Division Multiplexed (FDM) optical signal, and the node is configured to send the FDM optical signal over an optical cable to a second electro-optical converter located at a user's premises.

The node may be further configured to receive an FDM optical signal from the user's premises. The sent FDM optical signal may have Quadrature Amplitude Modulation (QAM) and Orthogonal Frequency-Division Multiplexing (OFDM), and the received FDM optical signal may have QAM and Orthogonal Frequency-Division Multiplexing Access (OFDMA). The FDM optical signals may be digital FDM optical signals. The sent and received FDM optical signals may be transmitted over a single optical cable within overlapping frequency bands but with at least partially offset center wavelengths. The sent and received FDM optical signals may have fully overlapping frequency bands. The node may further comprise a wavelength division multiplexer configured to multiplex and demultiplex optical signal wavelengths for upstream and downstream transmissions. There may be a wavelength division multiplexer disposed between the node and the user's premises, configured to multiplex and demultiplex optical signal wavelengths for upstream and downstream transmissions.

The node may be configured to send multiple FDM optical signals with QAM and OFDM over a plurality of optical cables to a plurality of electro-optical converters, each located at one of a plurality of users' premises, wherein the sent plurality of optical signals are sent at the same time. The node may be configured to receive, from the plurality of users' premises, a plurality of FDM optical signals with QAM and OFDMA, and the received signals may be received at the same time.

In an embodiment, a telecommunications method comprises: sending a baseband digital signal from a headend to a node, the node implementing one or more of Remote PHY (RPHY) and Remote MAC (RMAC) protocols; converting, by the node via a first electro-optical converter, the baseband digital signal into a Frequency-Division Multiplexed (FDM) optical signal; and sending the FDM optical signal over an optical cable to a second electro-optical converter located at a user's premises.

The method may also include receiving an FDM optical signal from the user's premises. The sent FDM optical signal may have Quadrature Amplitude Modulation (QAM) and Orthogonal Frequency-Division Multiplexing (OFDM), and the received FDM optical signal may have QAM and Orthogonal Frequency-Division Multiplexing Access (OFDMA). The FDM optical signals may be digital FDM optical signals. The sent and received FDM optical signals may be transmitted over a single optical cable within overlapping frequency bands but with at least partially offset center wavelengths. The sent and received FDM optical signals may have fully overlapping frequency bands.

The method may also comprise multiplexing upstream transmissions and demultiplexing downstream transmissions via a wavelength division multiplexer in the node. The method may also comprise multiplexing upstream transmissions and demultiplexing downstream transmissions via a wavelength division multiplexer between the node and the user's premises. The method may further comprise: sending, via the node, multiple FDM optical signals with QAM and OFDM over a plurality of optical cables to a plurality of electro-optical converters, each located at a one of a plurality of users' premises; and receiving, at the node, from the plurality of users' premises, a plurality of FDM optical signals with QAM and OFDMA; wherein the sent plurality of FDM optical signals are sent at the same time. The received plurality of FDM optical signals may be received at the same time.

### BRIEF DESCRIPTION OF THE DRAWINGS

FIG. 1 is a schematic drawing of a typical hybrid fiber/coaxial cable-based broadband/CATV telecommunications system.

FIG. 2 is a block diagram illustrating a system for cable television data transmission to a subscriber location via fiber-optics, according to an embodiment.

FIG. 3 is a schematic drawing of a fiber-based broadband/CATV telecommunications system according to an embodiment of the invention.

FIG. 4 is a chart showing frequency bands of several DOCSIS embodiments.

FIG. 5 is a chart showing loss along a long coax cable at various temperatures.

FIG. 6 is a chart showing frequency bands of several Optical FDX embodiments.

FIG. 7 is a schematic diagram of the “last mile” of a fiber-based broadband/CATV telecommunications system according to an embodiment of the invention.

FIG. 8 is a schematic diagram of an embodiment of an optical splitter system.

### DETAILED DESCRIPTION

Cable television (CATV) is a form of broadcasting that transmits programs to paying subscribers through a physical land-based infrastructure of coaxial cables or through a combination of fiber-optic and coaxial cables rather than through the airwaves. Thus, CATV networks provide a direct link from a transmission center, such as a headend, to a plurality of subscribers located at typically addressable remote locations, such as homes and businesses. Cable television networks based on coaxial distribution have been deployed for over half a century. The main function for early cable systems was to provide television service to areas where off-the-air reception was unavailable. In the past thirty years, most cities and county locations have been wired for cable television services. These services have evolved from 2-12 local off-air channels in the 1950s and 1960s to a variety of current services over a signal distribution service transmitting FM radio broadcasts, multi-channel TV programs, pay-per-view-movies (Video on Demand), information services such as videotext, and the like. Many cable systems now originate their own programming in an ever-increasing number of channels. In recent years, novel services have been made available to the subscribers, including interactive services. One such service regards a two-way, interactive communication involving access to established data communication networks, such as the Internet. CATV transmission, however, has been designed mostly to optimize downstream broadcasting; it was not configured for upstream receipt of information from subscribers. Even though upstream transmission has existed for years, recent advances and customer requirements have increased the kind and amount of upstream transmission to such an extent that the infrastructure for transmitting that upstream information has issues needing to be corrected and/or improved.

The signals that are carried over the coaxial cable delivery system are typically received at a headend facility. A CATV headend is the central transmission center operative to gather and to provide complex audio, visual, and data media throughout a geographical area, which can cover most or all of a small city. In big cities or metropolitan areas, multiple headend facilities cover separate areas but can be interconnected redundantly for reliable supply of signals. The signals at the headend are received through, for example, satellite receive antennas, antennas erected on a tower, microwave links, fiber-optic cables, and direct coaxial interconnects, and the external signals received through the various types of employed antennas include satellite, microwave, and local TV station broadcasts. Additionally, locally produced and prerecorded programs can be introduced into the system. The responsibility of the headend is to process and to combine the received signals for distribution to customers and businesses. In addition, the headend assigns a channel frequency to all the signals destined for cable distribution. These received signals are multiplexed into a group of channels that are spaced 6 MHz apart, which are then offered to the subscribers selectively or are bundled as packages. Pay-per-view and special pay channels are added by keying the subscribers' set-top boxes or by phone authorization from the subscribers. If an upstream channel is operative in the network, the option of electrical authorization can be provided to the subscribers.

Programming has increased from the local off-the-air channels to include local, regional, national, and international programming. More and more channels have been added over the years so that a typical cable system now might offer hundreds of channels with analog and digitally compressed services. Once the signals have been processed at the headend, they can be distributed to the coaxial system through fiber-optic cables, microwave transmitters, or directly from the headend over the coaxial network.

A CATV system comprises a plurality of elements, which are operative in maintaining the flow of electrical data information through a coaxial conductor or through a combination of fiber-optic and coaxial cables to subscribers. The infrastructure of the system is required to span vast urban areas by cables installed underground or on high poles. It is routinely expected that the transmitted signals be kept at their highest possible fidelity having the lowest possible random energy interference level and this ability requires the CATV provider to periodically adjust the signals at each interconnect location.

Coupled between the headend and the subscriber end of the CATV system is a system of cables. A plurality of trunk cables, constructed of large diameter coaxial cables or of a combination of coaxial and fiber-optic cables, carry the signals from the headend to a series of distribution points. A typical cable system architecture includes a main trunk cable that is connected between the headend and these distribution points, referred to as hub stations or trunk/bridger stations. One or more feeder cables feed off the trunk/bridger station. Feeder cables branch out from the trunks and are responsible for serving local neighborhoods. Each feeder cable contains a number of taps disposed along the length of the feeder cable, and each tap contains a number of ports. A drop cable is connected between each port and a subscriber end and forms the familiar coaxial cables that enter directly into a CATV subscriber's premises. Terminal equipment is connected to the drop cable inside a CATV subscriber's home through a wall outlet. Among the more common terminal devices are televisions, VCRs, DVRs, set-top boxes, converters, descramblers, cable modems, and splitters. For a system offering two-way communications, the subscriber end also has a terminal that transmits signals upstream, in the return path of the cable system.

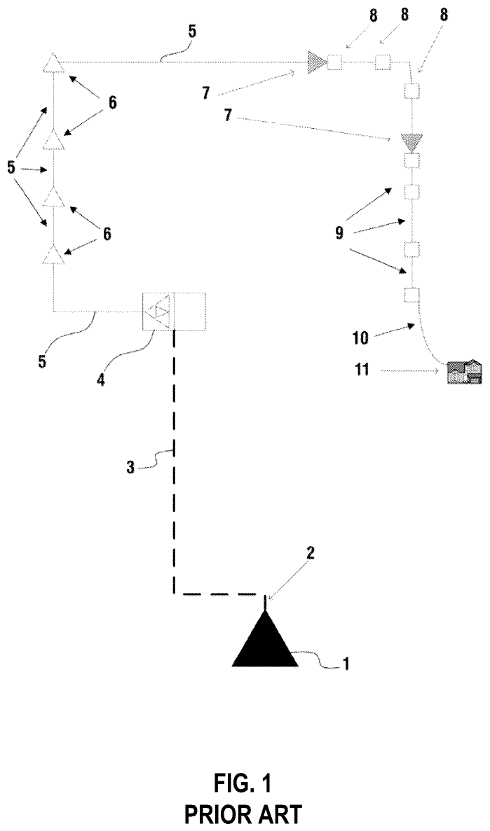

Traditionally, CATV systems were implemented with a Hybrid Fiber-Coax (HFC) architecture in which the headend or hub site performed the bulk of signal processing. For instance, the headend can serve as a central location to handle processing, routing, and combining signals. In some cases, while this centralized architecture worked well for years, the increase in demand for higher bandwidth (due to internet growth, streaming services, etc.) can cause challenges. FIG. 1 is a schematic drawing of a typical hybrid fiber/coaxial cable-based broadband/CATV telecommunications system, according to one or more embodiments. In some implementations, FIG. 1 can represent a typical CATV system that is currently deployed to service CATV subscribers. In the illustrative example shown in FIG. 1, forward CATV signals can originate at a headend facility 1 and can be supplied to a fiber-optic transmitter 2. The fiber-optic transmitter 2 can transmit the forward CATV signals to a fiber-optic node 4 over fiber-optic cable 3 (shown with a dashed line). The fiber-optic node 4 can also transmits reverse path signals from the subscribers to an optical receiver of the headend 1. An optical receiver in or adjacent to the fiber-optic transmitter 2 is not illustrated separately but can be typically located in the headend 1 to receive and process these return path signals from the optical node 4. The optical node 4 can process the optical signal and can provide a standard RF output signal. The standard RF output signal can then be provided to and carried over a coaxial cable 5 (a trunk or main line) to CATV trunk/network amplifiers 6 that are placed (in series) apart from one another with lengths of coaxial cable 5 therebetween. Depending upon the network architecture, the trunk/network amplifiers 6 can supply the signal to a network of distribution cables 9 that feeds signals to a smaller group of amplifiers, typically referred to as distribution or line-extender amplifiers 7. The distribution amplifiers 7 and distribution cable 9 can feed passive devices placed near an end user's location to tap off a main signal supply, which devices are sometimes referred to as distribution or subscriber taps 8. The distribution taps 8 can supply a signal tap for a subscriber's coaxial cable service drop 10. A subscriber service drop 10 enters a subscriber location 11 and provides the subscriber with desired services, such as television, high-speed Internet, and/or telephone.

It is noted that this embodiment is just one of many different types of CATV distribution architectures and many cable TV operators utilize different devices and equipment to deploy their services to the end subscriber. However, in many cases, systems that utilize coaxial cable to distribute their services deploy a similar architecture of fiber-optic cable, coaxial cable, amplifiers, and passive distribution devices.

The signals transmitted from the headend to the subscriber end can be contained within a particular frequency band—the forward (or downstream) path (or channel) of the CATV system. The signals transmitted from the subscriber end to the headend, or to some other upstream station, can be transmitted in a different frequency band (higher and/or lower) than the forward path frequency band and these upstream transmissions are referred to as the return (or upstream) path (or channel) of the CATV system. When transmitted over fiber-optic cables, losses in transmission can be much improved and more stable than when transmitted over coaxial cable. Accordingly, different techniques are required for improving transmission quality. The quality of transmission also can also be different with respect to the intermediate amplifiers used for fiber-optic and coaxial cables.

In some cases, coaxial cables can be constructed with a center conductor surrounded by a dielectric cross-section and an outer conductor, typically made from an aluminum outer shield. The coaxial cable attenuates the signal in a linear function of its conductor resistance. Different sizes of cable, therefore, attenuate the signal flow at different values due to the size of the center conductor and dielectric material. Booster amplifiers 6, 7 can be placed along the coaxial cable. The spacing of the amplifiers 6, 7 along a cable route can be determined by the loss of the route and is commonly selected based on the recommended operating gain of the amplifier 6, 7. Typically, the booster amplifiers 6, 7 can be located at points where the signal levels have been reduced to a pre-designed level. These amplifiers 6, 7 can be designed to add a minimum amount of noise and distortion to the processed signals. But, the amplifiers 6, 7 generate additional noise at various points in their circuitry. A ratio of total input noise power to a thermal noise floor is referred to as a noise figure of a given amplifier. As the amplifiers 6, 7 are not perfectly linear, they can also contribute additional distortions each time a signal is amplified. In some cases, due to the inherent contributions of noise and distortion (e.g., nonlinearity), the signal can only be amplified a certain number of times before the change in the signal, as compared to the signal provided at the headend 1, becomes unacceptable. The cascade effects of the amplifiers 6, 7 (e.g., net distortion introduce into the signal) typically results in a limited number of amplifiers 6, 7 in a continuous cascade. The limiting factors may include the type of modulation, the total number of channels, the per channel signal level, total composite power, and/or a desired performance at the end of the cascade. The Federal Communications Commission (FCC) has developed specific rules and regulations that govern the acceptable minimum performance to a cable customer. In particular, the FCC mandates that all signals provided over a cable system must maintain a peak to valley of less than or equal to less than 10 dBmV for systems of 300 MHz, plus 1 dB for each additional 100 MHz increments or fraction thereof. These rules and regulations must be taken into account during the design process of all cable systems.

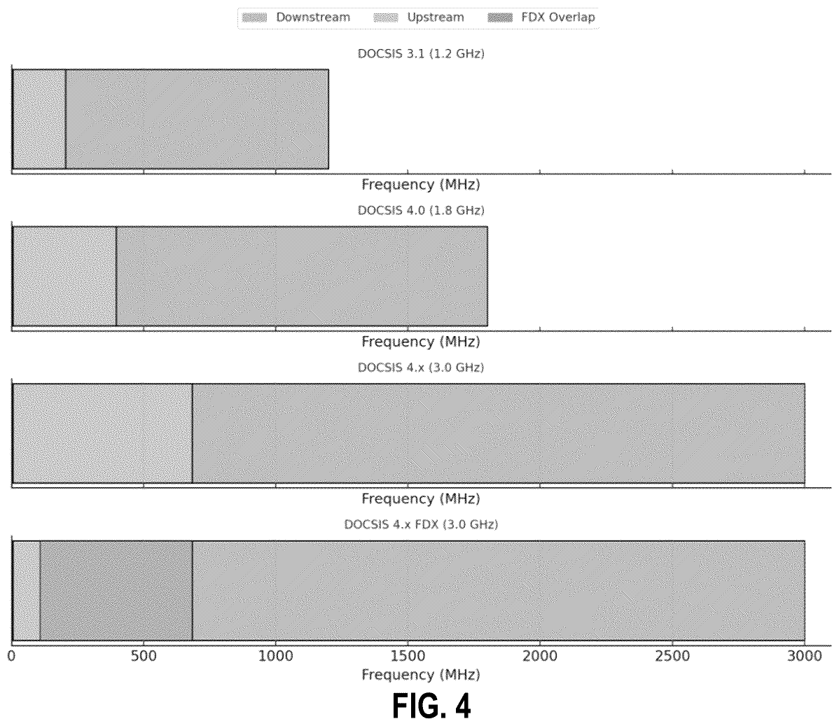

In some implementations, CATV systems have evolved to not only deliver TV signals but also provide broadband internet services using the Data Over Cable Service Interface Specification (DOCSIS) standard. The standard has improved in which DOCSIS 4.0 can support higher speeds and more efficient two-way communication. Some CATV systems today are implemented with a Distributed Access Architecture (DAA) that improves network performance, increase capacity, and reduce operational costs, which can be achieved by moving certain functions and features closer to the premises of a user or subscriber. DAA decentralizes much of the signal processing that traditionally occurred at the headend and distributes it out to remote nodes or devices closer to the subscriber. In a DAA setup, certain functions like signal modulation, MAC layer processing, and RF signal generation are pushed out of the headend and distributed into the network. Today, DAA architecture is more commonly used. Baseband digital 10G Dense Wavelength Division Multiplexing (DWDM) Ethernet can be used to transmit video data from headend to remote PHY (RPHY) RPHY or remote MAC (RMAC) nodes, e.g. over optical fiber. RF signals can be converted to DOCSIS 3.1, 4.0 and 4.x Quadrature Amplitude Modulation (QAM) and Orthogonal Frequency-Division-Multiplexing (OFDM) signals and transmitted via coaxial cable with splits and RF amplifiers in between to compensate for lossy cables and RF splits to the home. DOCSIS 4.0 and 4.x was designed to push HFC networks to much higher capacities by extending the usable spectrum up to 3 GHz and introducing both FDX (Full Duplex DOCSIS) and ESD (Extended Spectrum DOCSIS) options. See the ESD and FDX spectra in FIG. 4. ESD (Extended Spectrum DOCSIS) maximizes downstream, limited upstream where as FDX (Full Duplex DOCSIS) allows simultaneous upstream and downstream transmission in the same frequency band with symmetric throughput or capacity (˜10G, 15G or 25G both ways), however, it is more complex to deploy FDX systems due to RF/electrical echo cancelation challenges as frequency increases. FIG. 4 shows the spectrum of DOCSIS 3.1, 4.0, and 4.x spectrum including the US, DS, and US/DS (Full-Duplex overlap band, or echo-cancelled band) frequency ranges. For example, DOCSIS frequency ranges are as follows:
DOCSIS 3.1 US: 5-85 MHz, DS: 108-1218 MHz
DOCSIS 4.0 (ESD) US: 5-204 MHz, DS: 258-1794 MHz
DOCSIS 4.0 (FDX) US: 5-85 MHz, US/DS: 108-684 MHz, DS: 834-1218 MHz
DOCSIS 4.x (ESD) US: 5-684 MHz, DS: 834-3000 MHz
DOCSIS 4.x (FDX) US: 5-42 MHz, US/DS: 258-834 MHz, DS: 834-3000 MHz
   Note that DOCSIS 4.x (FDX) US/DS overlap band is shifted by 150 MHz DAA with Internet Protocol (IP) connections (digital fiber) and can create software-defined networks with improved network efficiency that support node evolution with RPHY and RMAC nodes, increased network capacity, improved end-of-line signal quality, higher modulation rates, higher bit rates, improved spectral efficiency, more wavelengths per fiber, and/or the like. DAA can also have operational and capital expenditure benefits including reduced head-end power, space and cooling requirements, hub consolidation, ability to add QAMs without changing RF combining network, and/or the like.

The CATV system as described herein is an improvement to HFC networks that uses RPHY or RMAC nodes in a DAA architecture. The CATV system as described replaces the coaxial cable, RF amplifiers, diplexers, coaxial splitters, and coaxial taps with fiber-optics such as optical fiber-cable, wavelength multiplexers and de-multiplexers, optical splitters, and optical taps. The CATV system described herein replaces the RF amplifiers and coaxial splitters with fiber-optics, which offer much greater signal quality and bandwidth. In traditional cable networks (using coaxial cables), RF splitters are used to divide RF signals carrying TV and internet data between multiple homes or devices. The splitters divide the electrical RF signal carried over coaxial cables. In fiber-based networks, fiber-optic taps and splitters can be used instead which divide the optical signal (carried over fiber-optic cables) between multiple subscribers or premises of subscribers. Optical signals are light-based and can be much more efficient for transmitting data over long distances compared to electrical RF signals. Fiber-optic splitters split light signals and allow for less signal degradation over long distances compared to coax splitters.

In some embodiments, the CATV system described herein can include an architecture with a downstream (DS) transmitter at the RPHY or RMAC node to send data (internet, TV signals, etc.) from a central location (headend/data centers) toward the premises of subscribers. In older HFC systems, multiple RF amplifiers were often used to maintain signal strength as it traveled from a node to the home of subscribers over coaxial cables. The CATV system described herein uses fiber-optics, eliminating the need for RF amplifiers between the RPHY or RMAC node and the home as fiber can carry signals over much longer distances without requiring amplification. This can simplify the network, reduce power consumption, reduce cost, and improve signal quality. The architecture of the CATV system describe herein can also include upstream (US) receiver optics at the RPHY or RMAC node and can be responsible for receiving data from the premises of subscribers back to the headend. In older systems, upstream amplifiers boosted the signal as it traveled over coax, while the CATV described herein uses fiber optic technology to eliminate the need for RF amplifiers along the coax line. In other words, the RPHY or RMAC node converts digital optical signals into RF by the PHY processor and then back to optical signals (e.g., to be transmitted over optical fiber) at the edge of the network or close to the premises of a subscriber. Before reaching the premises, the signal travels over a fiber-optic cable in its optical form, which does not need RF amplifiers to maintain signal strength. The RPHY or RMAC node may contain a DS transmit optical amplifier after the DS transmitter optics and an US receive optical amplifier before the US receiver optics (i.e., DS and US transceiver optics or electro-optical converters), respectively. Therefore, the system in the field may constitute fiber-optics with all passive optics and no active elements from the node to the premises.

The CATV described herein can use QAM to transmit the DOCSIS signals over fiber. The DOCSIS signals can include orthogonal frequency division multiplexing (OFDM) signals, which is used in newer versions of the DOCSIS specification. DOCSIS is the protocol used for internet services over cable. The DS and US digital transceiver optics transmits and receives DOCSIS-encoded baseband information over optical fiber (digital fiber) between the virtual CCAP core (vCCAP or vCore) and the RPHY or RMAC node. Digital fiber sends and receives digital optical signals DS and US on independent/separate fibers, respectively. Analog fiber uses bidirectional single fiber that contains both US and DS signals. Inside the RPHY or RMAC node the digital transceiver converts information to electrical signals and the PHY processor together with the RF block converter modulates DOCSIS information onto RF subcarriers where each subcarrier carries Digital QAM and OFDM encoded signals (e.g., digital radio frequency signals for transmitting data, TV, Internet, etc.). The electro-optical converter converts the RF subcarrier Digital QAM and OFDM signals into optical signals. The optical signals can travel over fiber optic cables for better efficiency. The Customer Premises Equipment (CPE) at the premises can convert them back into electrical signals, allowing delivery of higher capacity and higher signal fidelity data to many subscribers.

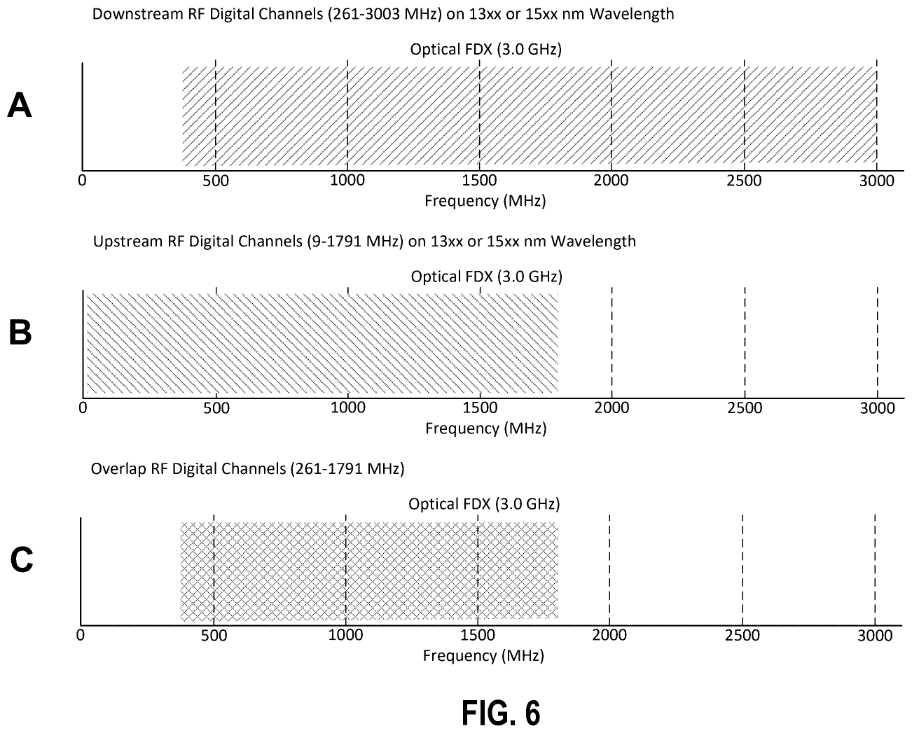

As no RF amplifiers are needed, the downstream and upstream optics can be multiple wavelengths or single wavelength. The term “RF digital optical signal” refers to an optical signal that has been multiplexed into subchannels, e.g., for last-mile transmission to or from a user premises. For example, RF digital optical signals may be sent DS and US between the node and the subscriber premises on a single fiber in partially or fully overlapping frequency bands, but with different wavelengths. This may be referred to as “Optical FDX” or “Full Duplex over Optics” or “NextGen Optical DOCSIS”. Instead of coax carrying the FDX echo-cancelled band (108-684 MHz in DOCSIS 4.0 (FDX) or 258-834 MHz in DOCSIS 4.x (FDX)), the digital optics signals are transported between the node and the CPE, without any need for echo cancelation, with slightly offset 13xx nm or 15xx nm center wavelengths, where the DS and US frequency spectrums are fully overlapping in the frequency band, for example, DS 42-3000 MHz, and US 258-834 MHz or even US 5-3000 MHz providing maximum capacity transport which will be impossible otherwise with RF amplifiers and coax cables. FIG. 6 shows an example of Optical FDX, wherein the downstream frequency band is shown in graph A, the upstream frequency band is shown in graph B, and the overlap, not otherwise simultaneously achievable without Optical FDX, is shown in graph C. The overlap may be a partial overlap or a complete overlap.

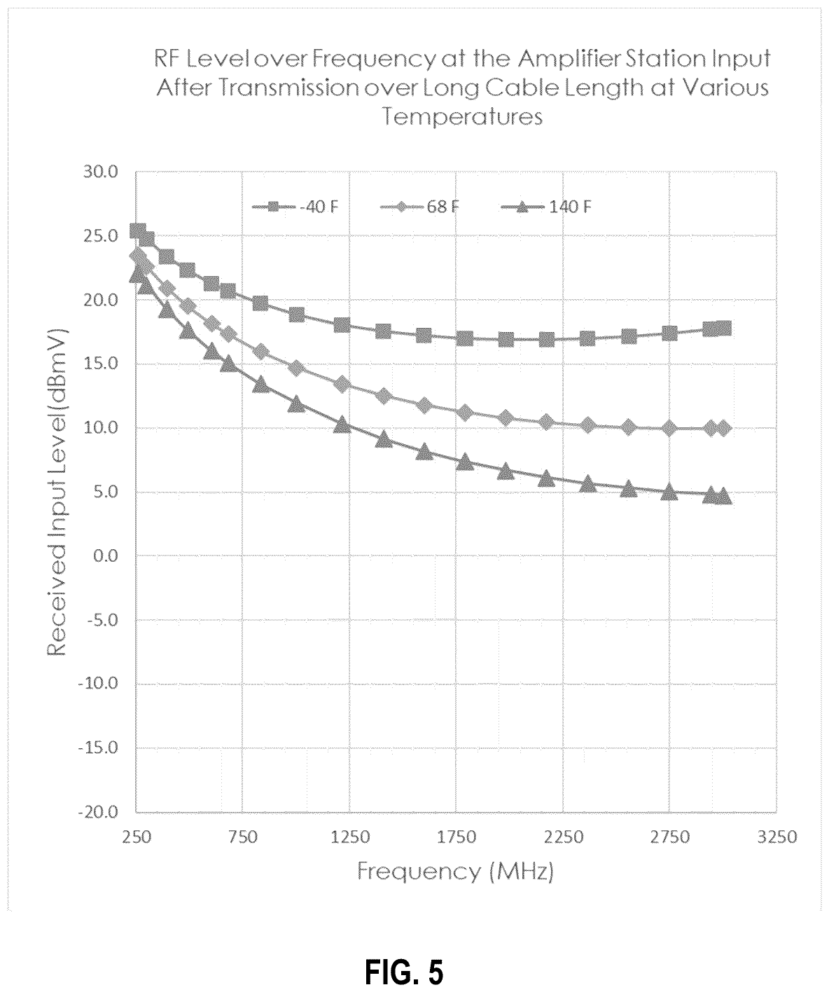

With coax cables, using both DOCSIS 4.x ESD and FDX is challenging due to much higher total composite power (TCP), composite carrier-to-noise (CCN), and wider bandwidth (i.e., 3 GHz or 6 GHZ) amplifier requirements. Furthermore, developing other essential components, such as, wider bandwidth AC bypass coils, electronically adjustable equalizers, and attenuators used inside amplifiers is cost prohibitive and technically challenging above 1.8 GHz DOCSIS applications. Therefore, attaining high capacity, and high signal fidelity DOCSIS 4.x or Next Gen DOCSIS with RF amplifier cascades over coax is impractical as high cost and high distortion will limit performance. See FIG. 5 for an example of the loss experienced over a long coax cable, which may require re-boosting the RF signal levels by in-line amplifier stations. However, with Optical FDX, there is low cost, as laser and photodetectors are utilized with negligible loss over 1-2 miles (3-4 km) of optical fiber cable, and only optical splitter losses.

For instance, 13xx or 15xx nanometer wavelengths can be used for transmitting signals downstream to a home. The 15xx nanometer signals fall in the C-band (1530-1565 nm) or L-band (1565-1625 nm) of the fiber-optic spectrum, which are common for long-distance data transmission using ITU-T DWDM Grid. For upstream traffic, 13xx nanometer wavelengths are typically used. 13xx nanometer wavelengths fall in the O-band (1260-1360 nm), which is commonly used for shorter distances and is efficient for upstream and downstream DOCSIS data for last-mile DOCSIS data over fiber. Recent 16 O-band wavelengths on ITU Grid are becoming attractive for Data Center and access fiber optic applications. Both up upstream and downstream optics can use different wavebands, or the same waveband but different center wavelengths of light to transmit data to different homes, which can be useful for managing bandwidth and capacity. The RPHY or RMAC node can include optical receivers that are not sensitive to the specific wavelength bands (C-band, L-band, or O-band) so they can detect signals across different wavelength ranges (1530-1625 nm for DS and 1260-1360 nm for US) without needing a different receiver for each specific wavelength. This flexibility allows for efficient management of signals coming from different or multiple sources and going to multiple destinations. In some implementations, the RPHY or RMAC node can include one or more optical amplifiers for upstream 13xx nanometer traffic due to split losses on fiber distance. Bismuth amplifiers can be used for O-band amplification and erbium amplifiers for C- and/or L-band amplification. As an alternative, the Tx and Rx optical amplifiers can be co-located to the node inside a housing connected to RPHY/RMAC node and to the last-mile network via fiber-optic cables.

In some embodiments, the CATV system described herein can include nodes implemented with full duplex DOCSIS (Optical FDX) to allow for simultaneous downstream and upstream transmission of data over the same wavelength or frequency spectrum over fiber-optics networks, enabling faster data speeds and efficient use of available spectrum. Optical FDX can provide subscribers a dedicated upstream RF bandwidth through, for example, using the O-band WDM optics window and downstream RF bandwidth C- and/or L-band WDM optics. The upstream optics can be limited by availability of low-cost optics at the home, for example, 5-3000 MHz (3 GHZ). The downstream optics can be capable of providing the 42-3000 MHz or 6 GHZ RF bandwidth with QAM and OFDM signals. The optical FDX bandwidth can provide a dedicated 50 Gb/s traffic to and from the home for future applications such as 3D holographic or VR gaming, video streaming and conferencing applications, etc.

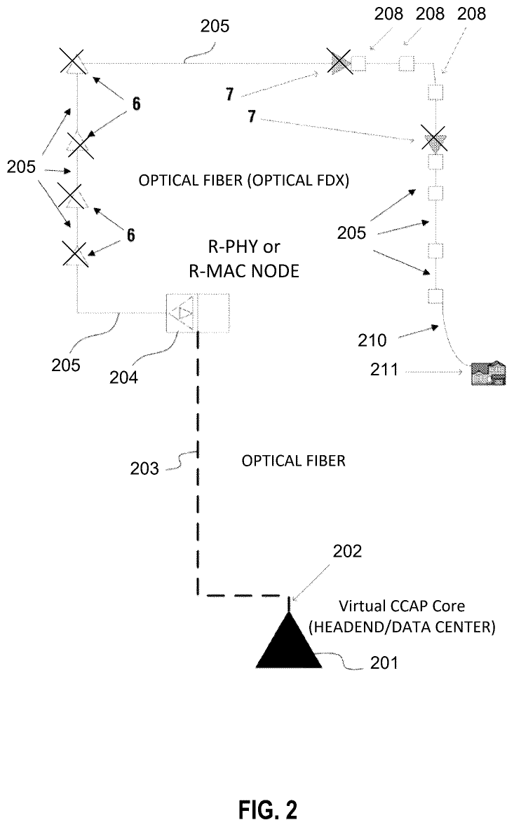

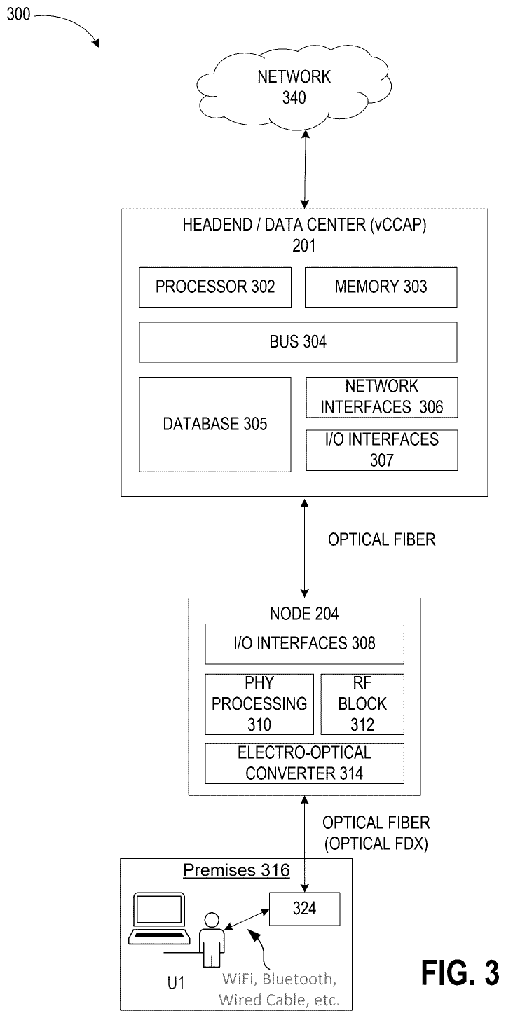

FIG. 2 is a schematic drawing of an embodiment of a fiber-based broadband/CATV telecommunications system, with comparisons to FIG. 1 shown. The “headend facility” may be a data center 201, which may be a vCCAP Core. There may be a fiber-optic transmitter 202, or the data center 201 may transmit (and receive) optical signals directly, over optical fiber cables 203, which runs between the data center 201 and a remote-PHY or remote-MAC node 204. The node 204 may be capable of receiving digital optical signals from the data center 201, and transmitting optical analog signals (e.g., DOCSIS) over optical cables 205. The signals traveling over the cables 205 will reach fiber-optic taps 208, from which fiber service drops 210 deliver the desired signals to the subscriber's premises 211. Explicitly noted in FIG. 2 is the lack of in-line amplifiers 6 and 7, which are typically unnecessary in low-loss fiber-based systems.

FIG. 2 is a block diagram illustrating system 300 for data transmission to subscriber location via fiber-optics, according to one or more embodiments. The system 300 includes a headend/data center 201, a network 340, nodes 204, and electro-optical converters 314, 324.

The headend 201 includes a processor 302, a database 305, network interfaces 306, I/O interfaces 307, and a memory 303 that communicate with each other, and with other components, via a bus 304. The bus 304 can include any of several types of bus structures including, but not limited to, a memory bus, a memory controller, a peripheral bus, a local bus, and any combinations thereof, using any of a variety of bus architectures. The headend 201 can also include multiple compute devices that can be used to implement a specially configured set of instructions for causing one or more of the compute devices to perform any one or more of the aspects and/or methodologies described herein.

The headend 201 can include network interfaces 306. The network interfaces 306 can be utilized for connecting the headend 201 to one or more of a variety of networks (e.g., network 340) and one or more remote devices connected thereto. I/O interface(s) 307 connect the electrical client side (electrical traces carrying lower speed digital signals electrically time-domain multiplex/demultiplexes lower speed digital signals by 8:1 or 16:1 to higher speeds) to optical network side (optical lanes/wavelength or fibers by modulates laser(s) directly or externally using optical modulators) such as 10 Gb/s, 25 Gb/s DWDM pluggable transceiver optics, or 50 Gb/s or 100 Gb/s coherent pluggable transceiver optics coupled with 15xx optical amplifiers such as SOAs, EDFAs, or RAMAN Amplifiers. The I/O interface(s) 307 can be any suitable component(s) that enable communication between internal components of the headend 201 and external devices. The network interfaces 306 can be configured to provide a wireless and/or wired connection to the network 340. In some implementations, the network interfaces 306 can include a router, gateway, ethernet, and/or the like.

The network 340 can include, for example, private network, a Virtual Private Network (VPN), a Multiprotocol Label Switching (MPLS) circuit, the Internet, an intranet, a local area network (LAN), a wide area network (WAN), a metropolitan area network (MAN), a worldwide interoperability for microwave access network (WiMAX®), an optical fiber (or fiber-optic)-based network, a Bluetooth® network, a virtual network, and/or any combination thereof. In some instances, the network can be a wireless network such as, for example, a Wi-Fi or wireless local area network (“WLAN”), a wireless wide area network (“WWAN”), and/or a cellular network. In other instances, the network can be a wired network such as, for example, an Ethernet network, a digital subscription line (“DSL”) network, a broadband network, and/or a fiber-optic network. In some instances, the headend 201 can use Application Programming Interfaces (APIs) and/or data interchange formats (e.g., Representational State Transfer (REST), JavaScript Object Notation (JSON), Extensible Markup Language (XML), Simple Object Access Protocol (SOAP), and/or Java Message Service (JMS)). The communications sent via the network 340 can be encrypted or unencrypted. In some instances, the network 340 can include multiple networks or subnetworks operatively coupled to one another by, for example, network bridges, routers, switches, gateways and/or the like.

The processor 302 can be or include, for example, a hardware-based integrated circuit (IC), or any other suitable processing device configured to run and/or execute a set of instructions or code. For example, the processor 302 can be a general-purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC) and/or the like. In some implementations, the processor 302 can be configured to run any of the methods and/or portions of methods discussed herein.

The memory 303 can be or include, for example, a random-access memory (RAM), a memory buffer, a hard drive, a read-only memory (ROM), an erasable programmable read-only memory (EPROM), and/or the like. In some instances, the memory can store, for example, one or more software programs and/or code that can include instructions to cause the processor 302 to perform one or more processes, functions, and/or the like. In some implementations, the memory 303 can include extendable storage units that can be added and used incrementally. In some implementations, the memory 303 can be a portable memory (e.g., a flash drive, a portable hard disk, and/or the like) that can be operatively coupled to the processor 302. The memory 303 can include various components (e.g., machine-readable media) including, but not limited to, a random-access memory component, a read-only component, and any combinations thereof. In one example, a basic input/output system (BIOS), including basic routines that help to transfer information between components within the headend 201, such as during start-up, can be stored in memory 303. The memory 303 can further include any number of program modules including, for example, an operating system, one or more application programs, other program modules, program data, and any combinations thereof.

The database 305 can store information generated by the processor 302 and/or received at the processor 302. In some implementations, the database 305 can include, for example, hard disk drives (HDDs), solid-state drives (SSDs), USB flash drives, memory cards, optical discs such as CDs and DVDs, and/or the like. In some implementations, the database 305 can include a database (e.g., a cloud database, a local database, etc.) that can be different from the memory 303. For example, the memory 303 can be volatile, meaning that its contents can be lost when the headend 201 is turned off. The database 305 can be configured to be persistent, meaning that its contents can be retained even when the headend 201 is turned off. In some implementations, the database 305 can be configured to organize and manage large amounts of data, whereas the memory 303 can be configured to be used for temporary storage of data and program instructions. In some implementations, the database 305 can be configured to provide efficient and reliable storage and retrieval of data and can include features such as, for example, indexing, querying, and transaction management, while the memory 303 can be configured for rapid access and manipulation of data.

The headend 201 can be communicatively coupled to one or more nodes (e.g., node 204) via digital fiber-optic links. The I/O interface(s) 307 of the headend 201 is communicatively coupled to the I/O interface(s) 308 of the node 204. In some implementations, the node 204 can be or include RPHY or RMAC nodes. The node 204 may comprise a PHY processing module 310, e.g., a 1×1 SED Remote PHY Device Module, and an RF block 312. The RF block 312 may up-convert or down-convert the digital baseband QAM and/or OFDM signal to an RF carrier frequency generating FDM signals. In some implementations, the node 204 can include one or more electro-optical converters 314. The electro-optical converter 314 can be configured to convert electrical signals into optical signals (and vice versa) for transmission over digital fiber-optic links. In broadband and telecommunication networks, the electro-optical converters can transmit data over long distances using light rather than electrical signals. In some instances, the electro-optical converter 314 can convert electrical signals coming from the PHY processing unit 310 into RF digital optical signals, which can be transmitted over fiber-optic links to electro-optical converters 324 in the CPE within the premises of subscribers 316.

A primary advantage of using fiber-optics is that optical signal losses over optical fiber is very low (0.2 dB/km in C- and L-band and 0.3 dB/km in O-band) and not frequency dependent and low temperature dependent compared RF signal losses over coax cable which is high and is both temperature- and frequency-dependent (0.5 dB/100 ft at 100 MHz and 3.3 dB/100 ft at 3000 MHz for CommScope P3 type 0.750 diameter coax cable). The total RF signal loss of optical fiber cable compared to coax cable for a 4 km transport is 2.4 dB (including the additional factor 2 due to optical to electrical conversion loss) versus 433 dB, respectively. Therefore, RF signal levels need to be boosted (amplified) in the field every ˜2,000 ft of coax cable transmission (see FIG. 1) whereas optical RF signal levels do not typically require amplification in the field (see FIG. 2). The fiber-optic system has extremely low power consumption as no amplification is required in the field. In coax systems the amplifier stations can consume 50-70 Watts, therefore, a 6-cascaded system has a power consumption >300 Watts. The fiber optic system may require a booster optical amplifier at the node, which introduces some noise and fiber nonlinearities when launched over +21 dBm exhibited within the first 10 km of transmission. The objective to launch +21 dBm power is to be able to split power levels distributively along the cable (see FIG. 2) similar to the coax cable transmission. The +21 dBm power provides 64 splits to homes with 3 dB margin for fiber losses assuming 0 dBm received optical power at the premises. The objective is to split powers to homes within the first 2 km, which is the case for last-mile application, so that the fiber nonlinearities can be reduced. Furthermore, fiber nonlinearities can be drastically reduced when using directly modulated lasers where the center wavelength of the laser is also frequency modulated by the information signal (this is a natural phenomenon when modulating lasers directly) eliminating certain nonlinearities over fiber transmission. Achieving +21 dBm optical power launched into the fiber is challenging when using 13xx nm waveband DS, but bismuth-doped optical amplifiers (BDFAs) and/or integrated semiconductor optical amplifiers (SOAs) may be used to achieve this. Similarly, when using 15xx nm waveband for DS to attain +21 dBm launch power, erbium-doped optical amplifiers (EDFAs) can be used. Another option to provide a higher power would be to use, for example, eight wavebands; each waveband may have 2 consecutive wavelengths in the O-Band or C-Band ITU grid wavelengths for transmitting DS information. Each waveband serves a cluster of homes, for example 16-32 homes; US wavelengths will have slightly offset center wavelengths that carries the US information. In this example, the laser power would be +12 dBm which is adequate to serve all homes without using the optical amplifier at the RPHY/RMAC node and at the CPE.

The electro-optical converters may also include optical and/or electrical transceivers. In some implementations, the node 204 and the electro-optical converters 314, 324 can be programmed to communicate with each other via frequency-division-multiplexing (FDM), modulated with single-carrier QAM (SC-QAM), multi-carrier OFDM or OFDMA, over fiber-optic links and/or a full-duplex communications protocol. FDM can be used such that multiple data streams (e.g., Internet, voice, video, etc.) can be modulated onto different frequency spectrums or wavelength channels within the total available bandwidth of the optical fiber. The electro-optical converters can be programmed to communicate with each other using Optical FDX. The signals can be transmitted simultaneously over the same optical fiber, with each signal occupying a separate wavelength or frequency range. The system 300 can allow for long-haul fiber-optic communications to carry multiple streams of data (e.g., TV channels) across long distances.

In some implementations, the electro-optical converters 314, 324 can be located near or at the premises of the user 316. For example, electro-optical converter 324 can be located at the home/premises 316 of user U1. In some implementations, the node 204 can include the electro-optical converter 314. In some implementations, the full-duplex communications protocol can be in DOCSIS (e.g., DOCSIS 3.1, 4.0, 4.x). In some implementations, no RF coaxial cable and/or amplifier can be used in the system 300. For instance, there is no RF coaxial cable and/or amplifier between the node 204 and the subscriber premises 316. In some implementations, a passive optical network can exist between the node 204 and the user premises 316.

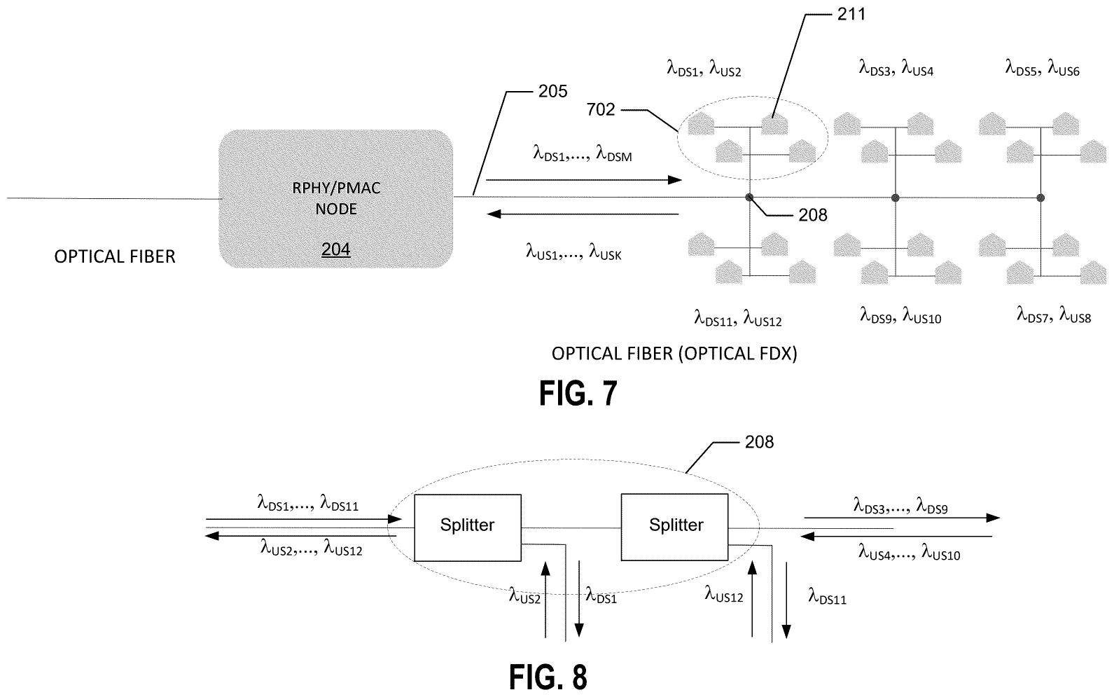

FIG. 7 shows a “zoomed-in” diagram example of the fiber system shown in FIG. 2, wherein the “last mile” portion, between the node 204 and the subscriber premises 211 (which may be the same as user premises 316). There may be a single optical cable 204 coming from the node 205, with one or more taps 208 to allow distribution to multiple premises 211. The cable 205 may carry all of the upstream and downstream signals for the user premises 211. To make the best use of the bandwidth, and thereby offer the most bandwidth to the premises 211, Optical FDX may be used, which allows the upstream and downstream frequency bands to overlap without crosstalk.

The optical taps/splitters 208 may be passive, or may be multiplexers/demultiplexers for US and DS signals. The taps 208 may send signals to clusters 702 of premises 211, and there may be additional taps/splitters between individual premises 211. US signals from the premises 211 may be time-domain multiplexed (TDM). For example, signals from each premises 211 within a cluster 702 may be TDM with respect to each other, but not with respect to signals from another cluster. This is possible due to Optical FDX, where US signals from each cluster can avoid interfering with each other due to having differing wavebands. This wavelength multiplexing enables greater utilization of the available bandwidth. As shown in FIG. 8, the taps/splitters 208 may, in some embodiments, comprise a plurality of splitters (and optionally multiplexers/demultiplexers)—e.g., one per cluster 702.

The channel capacity or required SNR (Signal to Noise Ratio) of coax (DOCSIS 3.1, 4.0, and 4.x) and optical fiber channels (Optical FDX or NextGen DOCSIS) can be determined using Shannon's Capacity Theorem. The DOCSIS DS and US spectrum is an FDM channel, composed of several QAM and OFDM or OFDMA subchannels. The QAM subchannels are 6 MHz wide for both US and DS, and the OFDM channels are 192 MHz wide for DS, and 96 MHz wide for US (bursty OFDM channels is known as OFDMA). The OFDM or OFDMA channel is further divided into subcarriers that are closely spaced at 25 kHz or 50 kHz within the 192 MHz or 96 MHz wide subchannels. The total capacity of FDM channels can be determined using Shannon's Capacity Theorem and summing each subchannel capacities:

$$C = {\sum }_{k = 1}^{N} {B}_{k} {log}_{2} ( 1 + S N {R}_{k} )$$

where N is the number of subchannels, Bₖ is the bandwidth of the subchannel (i.e., 6 MHz or 8 MHz), and SNRₖ is the signal-to-noise ratio in the subchannel. Each SC-QAM channel has a symbol rate of 5.360537 Msymbols/s (with 64-QAM, 256-QAM, 1024-QAM, etc.) and each OFDM (or OFDMA) channel has a symbol rate of 25,000 symbols/s per subcarrier (with 256-, 512-, 1024-, 2048, 4096-, 8192-, 16,384-QAM). The end of the line SNR (˜MER) requirement at the CPE for SC-QAM (256-QAM per subchannel) and for OFDM (4096-QAM per subcarrier) is 32-33 dB and 41-42 dB, respectively. See Table 1 for the SNR requirements for DOCSIS 4.x OFDM channels up to 16384-QAM modulation.

In an example, the worst-case system noise floor at each amplifier can be derived by assuming the outside plant temperature is at 60° C. (140° F.) and the inside amplifier housing temperature is 90° C. The amplifier station input losses, due to component excess insertion losses, contribute to the overall noise figure of about 10 dB in a 3 GHz system. The system (thermal) noise floor within the analog baseband channel bandwidth, NBW is 4 MHz, can be expressed as follows:

$$System Noise Floor = - 173 + N F + 10 \cdot {log}_{10} N B W + 48.75 = - 4 8.2 dBmV$$

For a 6-amplifier cascaded DOCSIS 4.x 3 GHz system, the minimum required per-channel level (PCL) at the amplifier input can be determined:

$$Min . PCL = S N R + 3.0 + 10 {log}_{10} 6 + System Noise Floor .$$

Using the required SNR for SC-QAM (256-QAM) and OFDM/OFDMA (4096-QAM) the minimum required input level is −5 dBmV and +4 dBmV, respectively. Assuming the amplifiers are spaced at 2,000 ft coax cable (6×2,000 ft of transport), similar to the DOCSIS 4.0 system, FIG. 5 shows the coax cable loss as a function of frequency increases dramatically. The required total composite power (TCP) can be found numerically or using Shannon's theorem for this system (note that the signal is launched from the RPHY node highly tilted into the cable to counter act the shaping loss induced by the cable as it is received at the input of the in-line amplifier, the act is repeated at each per amplifier output) as +82 dBmV. On the other hand, the TCP is kept at a moderate level as 69 dBmV for 1.8 GHz DOCSIS 4.0. It is difficult to develop an amplifier that is 20× higher in output power at the node and at each amplifier station deployed along the coax cable chain.

A second example provides an Optical FDX (Next Gen DOCSIS) system with a simple 13xx laser and a PIN diode receiver (electro-optic converter) at the node and CPE. with an output power of +18 dBm and detection at the premises at an optical power level +3 dBm. One can calculate the SNR by using the system parameters as follows:
Transmit Wavelength=13xx- or 15xx-nm
Transmit Power, Pt=+21 dBm
Modulation Index, m=0.015 per subchannel
Receive Power, Pr=1.0 mW
PIN Responsivity, R=1.0 A/W
NBW=4 MHz
Laser Noise, RIN=−160 dB/Hz
Shot Noise, Ns=2 qPr/R
Rx Thermal Noise, Nt=10 pA/√Hz
LNA Noise Figure, NF=3 dB
   Using the above system parameters, we determine the delivered min. PCL, system noise level, and the SNR as follows:

$$System Noise Floor = - 182 + N F + 10 \cdot {log}_{10} N B W + 48.75 = - 6 4.2 dBmV$$

$$min . Receive PCL = - 64.5 + 48.75 = - 1 5.75 dBmV$$

$$SNR = min . Receive Level - System Noise Floor = 48.5 dB$$

Inspection of Table 1 indicates that 14 OFDM/OFDMA (4096-QAM per subcarrier) blocks each 192 MHz wide (258-2946 MHz) may be easily transported over optics providing a total channel capacity/throughput of 25 Gb/s using NextGen DOCSIS 3 GHz systems using optical FDX. Furthermore, the new 16384-QAM modulation per subcarrier blocks can be transported over optics providing a total channel throughput of 30 Gb/s using 3 GHz optical FDX systems, whereas over coax cable this is challenging if not impossible given the high TCP requirements for each amplifier in the chain. This technique can be extended to 6 GHz optical FDX NextGen DOCSIS systems as well.

TABLE 1
DOCSIS 4.x SNR Requirements for
Various OFDM/OFDMA Modulation

| Modulation (per subcarrier) | SNR Requirement |
|---|---|
| 64-QAM | ~23-24 dB |
| 256-QAM | ~29-30 dB |
| 1024-QAM | ~35-36 dB |
| 2048-QAM | ~38-39 dB |
| 4096-QAM | ~41-42 dB |
| 8192-QAM (optional) | ~44-45 dB |
| 16384-QAM (lab/demo) | ~47-48 dB |

It is to be noted that any one or more of the aspects and embodiments described herein can be conveniently implemented using one or more machines (e.g., one or more compute devices that are utilized as a user compute device for an electronic document, one or more server devices, such as a document server, etc.) programmed according to the teachings of the present specification. Appropriate software coding can readily be prepared by skilled programmers based on the teachings of the present disclosure. Aspects and implementations discussed above employing software and/or software modules can also include appropriate hardware for assisting in the implementation of the machine executable instructions of the software and/or software module.

Such software can be a computer program product that employs a machine-readable storage medium. A machine-readable storage medium can be any medium that is capable of storing and/or encoding a sequence of instructions for execution by a machine (e.g., a compute device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random-access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software can also include information (e.g., data) carried as a data signal on a data carrier, such as a carrier wave. For example, machine-executable information can be included as a data-carrying signal embodied in a data carrier in which the signal encodes a sequence of instruction, or portion thereof, for execution by a machine (e.g., a compute device) and any related information (e.g., data structures and data) that causes the machine to perform any one of the methodologies and/or embodiments described herein.

All combinations of the foregoing concepts and additional concepts discussed herein (provided such concepts are not mutually inconsistent) are contemplated as being part of the subject matter disclosed herein. The terminology explicitly employed herein that also can appear in any disclosure incorporated by reference should be accorded a meaning most consistent with the particular concepts disclosed herein.

The drawings are primarily for illustrative purposes, and are not intended to limit the scope of the subject matter described herein. The drawings are not necessarily to scale; in some instances, various aspects of the subject matter disclosed herein can be shown exaggerated or enlarged in the drawings to facilitate an understanding of different features. In the drawings, like reference characters generally refer to like features (e.g., functionally similar and/or structurally similar elements).

The entirety of this application (including the Cover Page, Title, Headings, Background, Summary, Brief Description of the Drawings, Detailed Description, Embodiments, Abstract, Figures, Appendices, and otherwise) shows, by way of illustration, various embodiments in which the embodiments can be practiced. The advantages and features of the application are of a representative sample of embodiments only, and are not exhaustive and/or exclusive. Rather, they are presented to assist in understanding and teach the embodiments, and are not representative of all embodiments. As such, certain aspects of the disclosure have not been discussed herein. That alternate embodiments cannot have been presented for a specific portion of the innovations or that further undescribed alternate embodiments can be available for a portion is not to be considered to exclude such alternate embodiments from the scope of the disclosure. It will be appreciated that many of those undescribed embodiments incorporate the same principles of the innovations and others are equivalent. Thus, it is to be understood that other embodiments can be utilized and functional, logical, operational, organizational, structural and/or topological modifications can be made without departing from the scope and/or spirit of the disclosure. As such, all examples and/or embodiments are deemed to be non-limiting throughout this disclosure.

Also, no inference should be drawn regarding those embodiments discussed herein relative to those not discussed herein other than it is as such for purposes of reducing space and repetition. For example, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure.

The phrase “based on” does not mean “based only on,” unless expressly specified otherwise. In other words, the phrase “based on” describes both “based only on” and “based at least on.”

The terms “instructions” and “code” should be interpreted broadly to include any type of computer-readable statement(s). For example, the terms “instructions” and “code” can refer to one or more programs, routines, sub-routines, functions, procedures, etc. “Instructions” and “code” can comprise a single computer-readable statement or many computer-readable statements.

The term “modules” can be, for example, distinct but interrelated units from which a program may be built up or into which a complex activity may be analyzed. A module can also be an extension to a main program dedicated to a specific function. A module can also be code that is added in as a whole or is designed for easy reusability.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) can be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules can include, for example, a general-purpose processor, a field programmable gate array (FPGA), and/or an application specific integrated circuit (ASIC). Software modules (executed on hardware) can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

Various concepts can be embodied as one or more methods, of which at least one example has been provided. The acts performed as part of the method can be ordered in any suitable way. Accordingly, embodiments can be constructed in which acts are performed in an order different than illustrated, which can include performing some acts simultaneously, even though shown as sequential acts in illustrative embodiments. Put differently, it is to be understood that such features can not necessarily be limited to a particular order of execution, but rather, any number of threads, processes, services, servers, and/or the like that can execute serially, asynchronously, concurrently, in parallel, simultaneously, synchronously, and/or the like in a manner consistent with the disclosure. As such, some of these features can be mutually contradictory, in that they cannot be simultaneously present in a single embodiment. Similarly, some features are applicable to one aspect of the innovations, and inapplicable to others.

In addition, the disclosure can include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein can be implemented in a manner that enables a great deal of flexibility and customization as described herein.

All definitions, as defined and used herein, should be understood to control over dictionary definitions, definitions in documents incorporated by reference, and/or ordinary meanings of the defined terms.

The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

Unless specifically stated or obvious from context, the term “or,” as used herein, is understood to be inclusive.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A cable network system comprising:
a headend; and
a node communicatively coupled to the headend via digital fiber-optic links, the node implementing one or more of Remote PHY (RPHY) or Remote MAC (RMAC) protocols;
wherein the node comprises a first electro-optical converter configured to convert a baseband digital signal into a Frequency-Division Multiplexed (FDM) optical signal; and
wherein the node is configured to send the FDM optical signal over an optical cable to a second electro-optical converter located at a user's premises.

2. The cable network system of claim 1, wherein the node is further configured to receive an FDM optical signal from the user's premises.

3. The cable network system of claim 2, wherein the sent FDM optical signal has Quadrature Amplitude Modulation (QAM) and Orthogonal Frequency-Division Multiplexing (OFDM), and wherein the received FDM optical signal has QAM and Orthogonal Frequency-Division Multiplexing Access (OFDMA).

4. The cable network system of claim 2, wherein the FDM optical signals are digital FDM optical signals.

5. The cable network system of claim 2, wherein the sent and received FDM optical signals are transmitted over a single optical cable within overlapping frequency bands but with at least partially offset center wavelengths.

6. The cable network system of claim 5, wherein the sent and received FDM optical signals are transmitted over a single optical cable within fully overlapping frequency bands.

7. The cable network system of claim 5, wherein the node further comprises a wavelength division multiplexer configured to multiplex and demultiplex optical signal wavelengths for upstream and downstream transmissions.

8. The cable network system of claim 5, further comprising a wavelength division multiplexer between the node and the user's premises, and configured to multiplex and demultiplex optical signal wavelengths for upstream and downstream transmissions.

9. The cable network system of claim 5 wherein:
the node is configured to send multiple FDM optical signals with QAM and OFDM over a plurality of optical cables to a plurality of electro-optical converters, each located at one of a plurality of users' premises;
the node is configured to receive, from the plurality of users' premises, a plurality of FDM optical signals with QAM and OFDMA; and
the sent plurality of FDM optical signals are sent at the same time.

10. The cable network system of claim 9, wherein the received plurality of FDM optical signals are received at the same time.

11. A telecommunications method comprising:
sending a baseband digital signal from a headend to a node, the node implementing one or more of Remote PHY (RPHY) and Remote MAC (RMAC) protocols;
converting, by the node via a first electro-optical converter, the baseband digital signal into a Frequency-Division Multiplexed (FDM) optical signal; and
sending the FDM optical signal over an optical cable to a second electro-optical converter located at a user's premises.

12. The telecommunications method of claim 11, further comprising receiving an FDM optical signal from the user's premises.

13. The telecommunications method of claim 12, wherein the sent FDM optical signal has Quadrature Amplitude Modulation (QAM) and Orthogonal Frequency-Division Multiplexing (OFDM), and wherein the received FDM optical signal has QAM and Orthogonal Frequency-Division Multiplexing Access (OFDMA).

14. The telecommunications method of claim 12, wherein the FDM optical signals are digital FDM optical signals.

15. The telecommunications method of claim 12, wherein the sent and received FDM optical signals are transmitted over a single optical cable within overlapping frequency bands but with at least partially offset center wavelengths.

16. The telecommunications method of claim 15, wherein the sent and received FDM optical signals are transmitted over a single optical cable within fully overlapping frequency bands.

17. The telecommunications method of claim 15, further comprising multiplexing upstream transmissions and demultiplexing downstream transmissions via a wavelength division multiplexer in the node.

18. The telecommunications method of claim 15, further comprising multiplexing upstream transmissions and demultiplexing downstream transmissions via a wavelength division multiplexer between the node and the user's premises.

19. The telecommunications method of claim 15, further comprising:
sending, via the node, multiple FDM optical signals with QAM and OFDM over a plurality of optical cables to a plurality of electro-optical converters, each located at a one of a plurality of users' premises; and
receiving, at the node, from the plurality of users' premises, a plurality of FDM optical signals with QAM and OFDMA;
wherein the sent plurality of FDM optical signals are sent at the same time.

20. The telecommunications method of claim 19, wherein the received plurality of FDM optical signals are received at the same time.
